(19) United States
(12) Patent Application Publication
(10) Pub. No.: US 2010/0220420 A1
(43) Pub. Date: Sep. 2, 2010

(54) VOLTAGE PROTECTION CIRCUIT

(75) Inventors: TIAN-YI WANG, Shanghai (CN); JIE-YING SHEN, Shanghai (CN); LI-YU LI, Shanghai (CN)

Correspondence Address: PCE INDUSTRY, INC.;ATT. Steven Reiss, 288 SOUTH MAYO AVENUE, CITY OF INDUSTRY, CA, 91789, US

(73) Assignees: AMBIT MICROSYSTEMS (SHANGHAI) LTD., SHANGHAI (CN); HON HAI PRECISION INDUSTRY CO., LTD., Tu-Cheng (TW)

(21) Appl. No.: 12/481,587

(22) Filed: Jun. 10, 2009

(30) Foreign Application Priority Data
Feb. 27, 2009 (TW) 98203023

(51) Int. Cl. H02H 3/20

(52) U.S. Cl. 361/90

(57) ABSTRACT

A voltage protection circuit includes a first voltage dividing circuit, a second voltage dividing circuit, a transistor and a switching power supply integrated circuit. The first resistor includes a first resistor and a second resistor. The second voltage dividing circuit includes a third resistor and a fourth resistor. The transistor with a base connected to a common end of the first resistor and the second resistor, a collector connected to a common end of the third resistor and the fourth resistor, an emitter connected to ground. The switching power supply integrated circuit includes an input pin, an enable pin and an output pin.

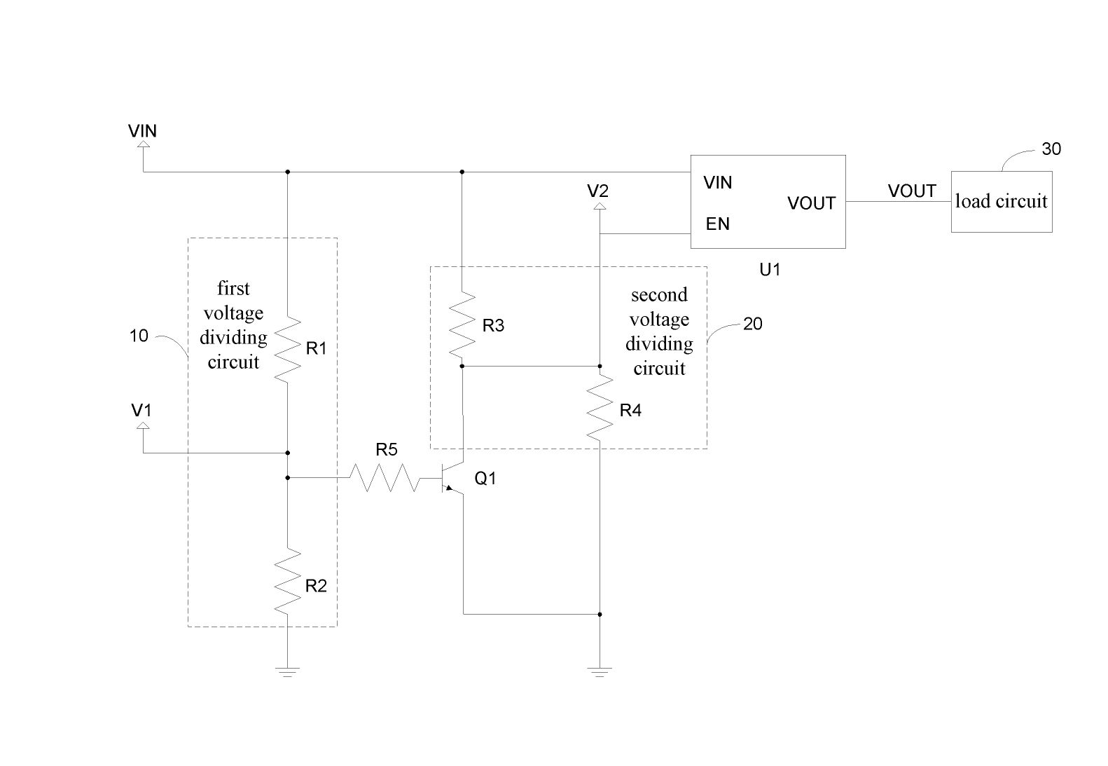

### BACKGROUND

1. Technical Field

Embodiments of the present disclosure relate to protection circuits, and particularly to a voltage protection circuit.

2. Description of Related Art

An integrated circuit includes an enable pin to control working states of the control circuit. When voltage input to the enable pin is at or higher than a normal working voltage, the integrated circuit works normally, and when voltage input to the enable pin is lower than a normal working voltage, the integrated circuit does not work normally. Therefore, the integrated circuit can be used for under-voltage protection of an electronic circuit. However, the electronic circuit further needs over-voltage protection.

### BRIEF DESCRIPTION OF THE DRAWINGS

The FIGURE is a circuit diagram of one embodiment of a voltage protection circuit.

### DETAILED DESCRIPTION

The FIGURE is a circuit diagram of one embodiment of a voltage protection circuit. In this embodiment, the voltage protection circuit is operable to protect an integrated circuit U1 and a load circuit 30. The voltage protection circuit includes a first voltage dividing circuit 10, a second voltage dividing circuit 20, and a transistor Q1. In this embodiment, the integrated circuit U1 is a switching power supply integrated circuit or other types of integrated circuits.

The first voltage dividing circuit 10 includes a first resistor R1 and a second resistor R2. A first end of the first resistor R1 connects to a power source, and the second resistor R2 is connected between a second end of the first resistor R1 and ground. The second voltage dividing circuit 20 includes a third resistor R3 and a fourth resistor R4. A first end of the third resistor R3 connects to the power source, and the fourth resistor R4 is connected between a second end of the third resistor R3 and ground. A base of the transistor Q1 connects to a common end of the first resistor R1 and the second resistor R2, a collector of the transistor Q1 connects to a common end of the third resistor R3 and the fourth resistor R4, and an emitter of the transistor Q1 connects to ground. The integrated circuit U1 includes an input pin (power pin) VIN, an output pin VOUT, and an enable pin EN. The input pin VIN connects to an external power source, the output pin VOUT is operable to output a voltage input from the external power source, and the enable pin EN connects to the common end of the resistor R3 and the resistor R4.

The voltage protection circuit further comprises a resistor R5. A first end of the resistor R5 connects to the common end of the first resistor R1 and the second resistor R2, and a second end of the resistor R5 connects to the base of the transistor Q1. The resistor R5 is operable to limit a voltage of the base of the transistor Q1.

In this embodiment, a voltage VIN is input to the voltage protection circuit and resulting in an output voltage VOUT. When the voltage input to the integrated circuit U1 is bigger than a normal working voltage, the integrated circuit U1 works normally and outputs VOUT. The input voltage V2 of the enable pin EN is about 1V, in one example.

In this embodiment, the first voltage dividing circuit 10 divides the voltage VIN of the voltage protection circuit to get a voltage V1, V1=(VIN*R2)/(R1+R2). The second voltage dividing circuit 20 divides the voltage VIN of the voltage protection circuit to get a voltage V2, V2=(R4*VIN)/(R4+R3). When the voltage VIN is over-voltage, V1 turns on the transistor Q1, and the transistor Q1 works normally. The enable pin EN of the integrated circuit U1 is connected to ground via the transistor Q1, so that a voltage of the enable pin EN of the integrated circuit U1 is smaller than a normal working voltage 1V so as to stop the integrated circuit U1 working. Thus the integrated circuit U1 and the load circuit 30 are protected from over-voltages.

When the voltage VIN is under-voltage, the first voltage dividing circuit 10 turns off the transistor Q1, and the second voltage dividing circuit 20 produces a voltage V2 smaller than the normal working voltage 1V so as to stop the integrated circuit U1 working. Thus, the integrated circuit U1 and the load circuit 30 are protected from under-voltages.

Although the features and elements of the present disclosure are described in various inventive embodiment in particular combinations, each feature or element can be configured alone or in various within the principles of the present disclosure to the full extent indicated by the broad general meaning of the terms in which the appended claims are expressed.

What is claimed is:

1. A voltage protection circuit for a load circuit, comprising:
a first voltage dividing circuit, comprising:
a first resistor with a first end connected to an external power source; and
a second resistor connected between a second end of the first resistor and ground;
a second voltage dividing circuit, comprising:
a third resistor with a first end connected to the external power source; and
a fourth resistor connected between a second end of the third resistor and ground; and
a transistor with a base connected to a common end of the first resistor and the second resistor, a collector connected to a common end of the third resistor and the fourth resistor, and an emitter connected to ground;
a switching power supply integrated circuit, comprising:
an input pin connected to the external power source;
an enable pin connected to the common end of the third resistor, the fourth resistor, and the collector of the transistor;
an output pin operable to output a voltage of the external power source;
wherein when the voltage of the external power source is over-voltage, the first voltage dividing circuit turns on the transistor, and the enable pin of the switching power supply integrated circuit is connected to ground via the transistor, such that a voltage of the enable pin of the integrated circuit is smaller than a normal working voltage of the load circuit such that the switching power supply integrated circuit stops outputting the over-voltage to the load circuit;
wherein when the voltage of the external power source is under-voltage, the first voltage dividing circuit turns off the transistor, and the second voltage dividing circuit produces a voltage smaller than the normal working voltage of the enable pin of the switching power supply integrated circuit, so that the switching power supply integrated circuit stops outputting the under-voltage to the load circuit.

2. The voltage protection circuit as claimed in claim 1, further comprising a fifth resistor with a first end connected to the common end of the first resistor and the second resistor, and a second end connected to the base of the transistor, wherein the fifth resistor is operable to limit a current flowing through the base of the transistor.

3. A voltage protection circuit connected between an external power source and an integrated circuit with a power pin and an enable pin, the voltage protection circuit comprising:
a first voltage dividing circuit connected between the external power source and ground, operable to output a first voltage dividing signal;
a transistor with a base receiving the first voltage dividing signal, a collector connected to the enable pin of the integrated circuit, and an emitter connected to ground;
a second voltage dividing circuit connected between the external power source and ground, operable to output a second voltage dividing signal to the enable pin of the integrated circuit;
wherein when the voltage of the external power source is over-voltage, the first voltage dividing circuit outputs the first voltage dividing signal to turn on the transistor, and the enable pin of the integrated circuit is substantially grounded by way of the collector and the emitter of the transistor so as to disable the integrated circuit;
wherein when the voltage of the external power source is under-voltage, the first voltage dividing circuit turn off the transistor, and the second voltage dividing circuit outputs the second voltage dividing signal to the enable pin of the integrated circuit and disable the integrated circuit.
